(19) United States
(12) Patent Application Publication
(10) Pub. No.: US 2025/0192256 A1
(43) Pub. Date: Jun. 12, 2025

(54) APPARATUS AND METHOD FOR IDENTIFYING LOCATION OF BATTERY MODULE AND BATTERY DIAGNOSTIC SYSTEM

(71) Applicant: SAMSUNG SDI CO., LTD., Yongin-si (KR)

(72) Inventor: Min Su KIM, Suwon-si (KR)

(21) Appl. No.: 18/656,656

(22) Filed: May 7, 2024

(30) Foreign Application Priority Data
Dec. 11, 2023 (KR) 10-2023-0178974

(51) Int. Cl. H01M 10/48; H01M 10/42

(52) U.S. Cl. CPC H01M 10/482; H01M 10/425; H01M 2010/4271; H01M 2010/4278

(57) ABSTRACT

A battery module location identification apparatus, method and system which identifies a location of a target battery module among a plurality of battery modules included in a battery pack using a sound signal generated from the target battery module, the battery module location identification apparatus including a microphone array having a plurality of microphones, a camera and a processor connected to the microphone array and the camera, wherein the processor generates location information of the target battery module based on an image of the plurality of battery modules captured by the camera and a sound signal received from the microphone array.

### CROSS-REFERENCE TO RELATED APPLICATION

This application claims priority to and the benefit of Korean Patent Application No. 10-2023-0178974, filed on Dec. 11, 2023, the disclosure of which is incorporated herein by reference in its entirety.

### BACKGROUND

### 1. Field

Aspects of embodiments of the present disclosure relate to a battery module location identification apparatus and method and a battery diagnosis system capable of identifying the location of a faulty battery module.

### 2. Description of the Related Art

A secondary battery is a battery that can be charged and discharged, unlike a primary battery that cannot be recharged. Low-capacity secondary batteries are used in small portable electronic devices such as smartphones, feature phones, notebook computers, digital cameras, and camcorders, and high-capacity secondary batteries are widely used as power sources for driving motors and power storage batteries in hybrid and electric vehicles. Such a secondary battery includes an electrode assembly composed of a positive electrode and a negative electrode, a case for accommodating the electrode assembly, electrode terminals connected to the electrode assembly, and the like.

A battery module formed with a plurality of unit battery cells coupled in series and/or parallel is used as a rechargeable battery, and the rechargeable battery may provide high-energy density, for example, for driving a motor of a hybrid vehicle. That is, for example, a battery module is formed by interconnecting electrode terminals of a plurality of unit battery cells according to the amount of power required to implement a high-power rechargeable battery for an electric vehicle. One or more battery modules are mechanically and electrically integrated to form a battery pack.

A lifetime of the battery module may be limited due to degradation, and the battery module may become unusable due to a failure. A faulty module may cause failure and performance degradation of the battery pack. Accordingly, the battery module in which the failure occurs among the battery modules included in the battery pack needs to be replaced, but it is conventionally difficult to identify an actual location of the faulty battery module among the battery modules included in the battery pack, and thus there is a problem that a lot of time and money are required to replace the battery module in which the failure occurs.

The above-described information is only for facilitating understanding of the background herein.

### SUMMARY

Embodiments include A battery module location identification apparatus which identifies a location of a target battery module among a plurality of battery modules included in a battery pack using a sound signal generated from the target battery module, the battery module location identification apparatus including a microphone array having a plurality of microphones, a camera and a processor connected to the microphone array and the camera, wherein the processor generates location information of the target battery module based on an image of the plurality of battery modules captured by the camera and a sound signal received from the microphone array.

The processor may identify a region of each battery module from the image, identify a generation location of the sound signal, may identify a battery module corresponding to a region including the generation location of the sound signal as the target battery module and may generate information about the region of the target battery module as the location information.

The processor may identify the generation location of the sound signal based on a strength of the sound signal received from each of the plurality of microphones at a reference location.

The battery module location identification apparatus may further include a moving device which moves a main body including the microphone array and the camera on a plane parallel to an upper surface of the battery pack.

The processor may move the main body to a location where a strength of the sound signal received from each of the plurality of microphones is a same from the moving device, identify a location of the main body based on the image captured by the camera and identify the location of the main body as the generation location of the sound signal.

The sound signal may include identification information of the target battery module and the processor may detect the identification information of the target battery module from the sound signal and match and store the detected identification information and the location information of the target battery module.

Embodiments include a battery module location identification method which identifies a location of a target battery module among a plurality of battery modules included in a battery pack using a sound signal output from the target battery module, the battery module location identification method including capturing, by a camera, an image of the plurality of battery modules, receiving a sound signal from a microphone array and generating location information of the target battery module based on the image captured by the camera and the sound signal received from the microphone array.

The generating of the location information may include identifying a region of each battery module from the image, identifying a generation location of the sound signal, identifying a battery module corresponding to a region including the generation location of the sound signal as the target battery module and generating information about the region of the target battery module as the location information.

The identifying of the generation location may include identifying the generation location of the sound signal based on a strength of the sound signal received from each of a plurality of microphones of the microphone array at a reference location.

The identifying of the generation location of the sound signal may include moving a main body including the microphone array and the camera to a location where a strength of the sound signal received from each of a plurality of microphones included in the microphone array is a same from a moving device, identifying a location of the main body based on the image captured by the camera and identifying the location of the main body as the generation location of the sound signal.

The battery module location identification method may further include detecting identification information of the target battery module from the sound signal and matching and storing the detected identification information and the location information of the target battery module.

Embodiments include a battery diagnosis system. The battery diagnosis system includes a plurality of subordinate battery management systems (BMSs) included in battery modules and a primary battery management system (BMS) which communicates with the plurality of subordinate BMSs, wherein the primary BMS determines some of a plurality of battery modules included in a battery pack as location confirmation targets and repeatedly performs a process of selecting one battery module included in the location confirmation targets as a target battery module and outputting a sound generation signal to one of the subordinate BMSs included in the target battery module while changing the target battery module, and if the sound generation signal is received, the one of the subordinate BMSs generates a sound signal from a sound wave generator included in the target battery module.

The primary BMS may identify one or more faulty battery modules among the plurality of battery modules and may determine the one or more faulty battery modules as the location confirmation targets.

If all subordinate BMSs included in the faulty battery modules are operating normally, the primary BMS determines the one or more faulty battery modules as the location confirmation targets.

If at least one of the one or more faulty battery modules is not operating normally, the primary BMS determines remaining battery modules excluding the one or more faulty battery modules as the location confirmation targets.

The subordinate BMS includes identification information of the target battery module in the sound signal.

The battery diagnosis system may further include a location identification apparatus including a microphone array, the microphone array including a plurality of microphones and a camera, wherein the location identification apparatus generates location information of the target battery module based on an image of a plurality of battery modules captured by the camera and a sound signal received from the microphone array.

The location identification apparatus may identify a region of each battery module from the image, identify a generation location of the sound signal and generate information about a region including the generation location of the sound signal as the location information of the target battery module.

If reception of the sound signal has ended, the location identification apparatus identifies a battery module for which the location information is completely generated as the location confirmation target, and if the battery module included in the location confirmation target is a faulty battery module, the location identification apparatus collects and outputs location information of all the battery modules included in the location confirmation targets.

If the battery module included in the location confirmation target is not a faulty battery module, the location identification apparatus generates location information of remaining battery modules excluding the battery modules included in the location confirmation targets and collects and outputs location information of the remaining battery modules.

### BRIEF DESCRIPTION OF DRAWINGS

Features will become apparent to those of ordinary skill in the art by describing in detail exemplary embodiments with reference to the attached drawings, in which:

FIG. 1 is a block diagram illustrating a battery diagnosis system according to one or more embodiments of the present disclosure;

FIG. 2 is a view illustrating a location identification apparatus according to one or more embodiments of the present disclosure;

FIG. 3 is a view illustrating an operating process of the location identification apparatus according to one or more embodiments of the present disclosure;

FIGS. 4A and 4B illustrate another operating process of the location identification apparatus according to one or more embodiments of the present disclosure;

FIG. 5 is a flowchart illustrating an operating method of a primary battery management system (BMS) and a subordinate BMS according to one or more embodiments of the present disclosure;

FIG. 6 is a flowchart illustrating an operating method of the location identification apparatus according to one or more embodiments of the present disclosure; and

FIG. 7 is a flowchart illustrating another operating method of the location identification apparatus according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present. Like reference numerals refer to like elements throughout.

Terms and words used in the present specification and claims should not be interpreted as being limited to commonly used meanings or meanings in dictionaries and should be interpreted as having meanings and concepts which are consistent with the technological scope of the present disclosure based on the principle that the inventors have appropriately defined concepts of the terms in order to describe in the best way. Therefore, since the embodiments described in this specification and components illustrated in the drawings are only some exemplary embodiments and do not represent the overall technological scope of the present disclosure, it should be understood that there may be various equivalents or modifications replacing the exemplary embodiments at the time of filing of this application. In addition, the terms “comprise,” “include,” “comprising,” and/or “including” used herein specify the presence of stated shapes, numbers, steps, operations, members, elements, and/or groups thereof but do not preclude the presence or addition of one or more other shapes, numbers, operations, members, elements, and/or groups thereof. In addition, if the embodiments of the present disclosure are described, the terms “may” or “may be” may include “one or more embodiments of the present disclosure.”

Further, in order to facilitate understanding of the present disclosure, the accompanying drawings are not drawn to scale, and the dimensions of some components may be exaggerated. In addition, like reference numerals may be assigned to like elements in different embodiments.

The statement that “two comparative objects are the same” means “the two comparative objects are substantially the same.” Therefore, the term “substantially the same” includes a case in which there is a deviation considered as a low level in the art, for example, a deviation of 5% or less. In addition, the description “some parameters are uniform within a certain region” may mean that “some parameters are uniform from an average perspective.”

Although terms such as first, second, or the like may be used for describing various elements, the elements are not limited by the terms. These terms are only used to distinguish one element from another element, and unless otherwise specifically described, a first element may also be a second element.

Throughout the specification, unless specifically described otherwise, each element may be singular or a plurality.

A first element disposed “above or under” or “on or below” a second element may include the first element being disposed in contact with an upper or lower surface of the second element or a third element interposed between the first element and the second element disposed above or under the first element.

It should be understood that, if a first element is referred to as being “connected,” “coupled,” or “linked” to a second element, although the first element may be directly connected or linked to the second element, it should be understood that a third element may be interposed therebetween, or the elements may be connected, coupled, or linked through other elements. In addition, if a first part is referred to as being “electrically connected” to a second part, it includes not only a case in which the first part is “directly connected” to the second part but also a case in which the first part is “connected” to the second part with a third element interposed therebetween.

Throughout the specification, unless otherwise specifically described, “A and/or B” means “A,” “B,” or “A and B.” That is “and/or” includes all combinations or any combination of a plurality of listed items. Unless otherwise specifically described, “C to D” means “more than or equal to C and less than or equal to D.”

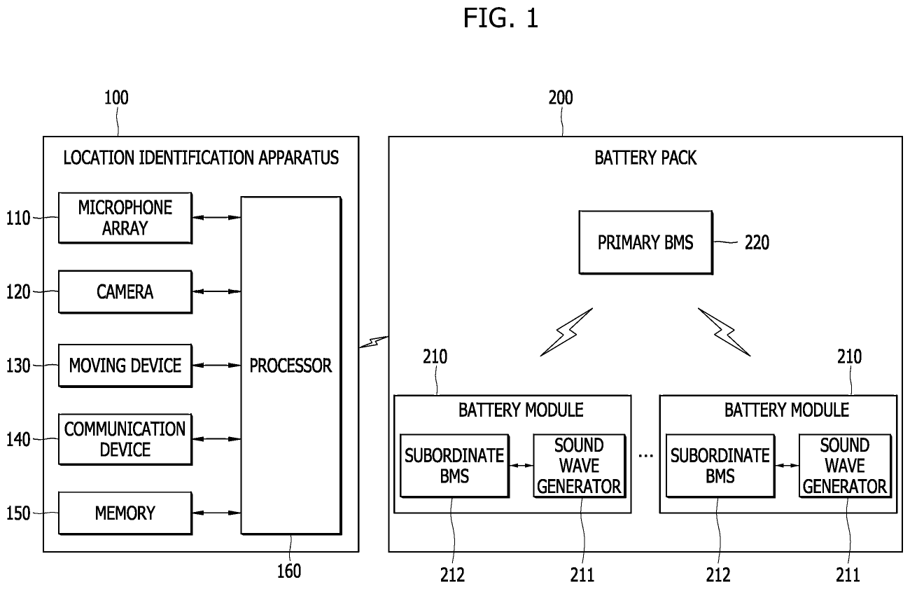

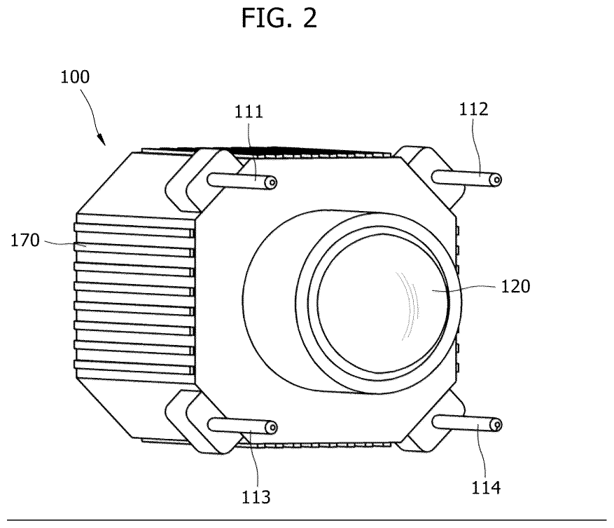

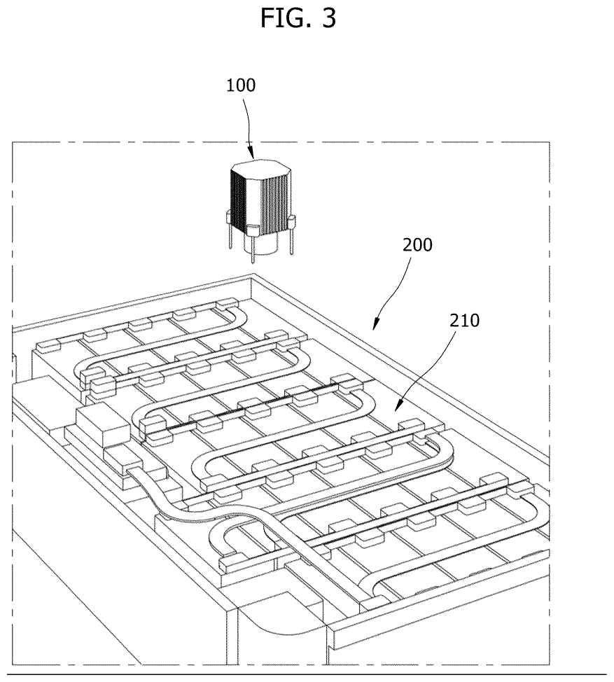

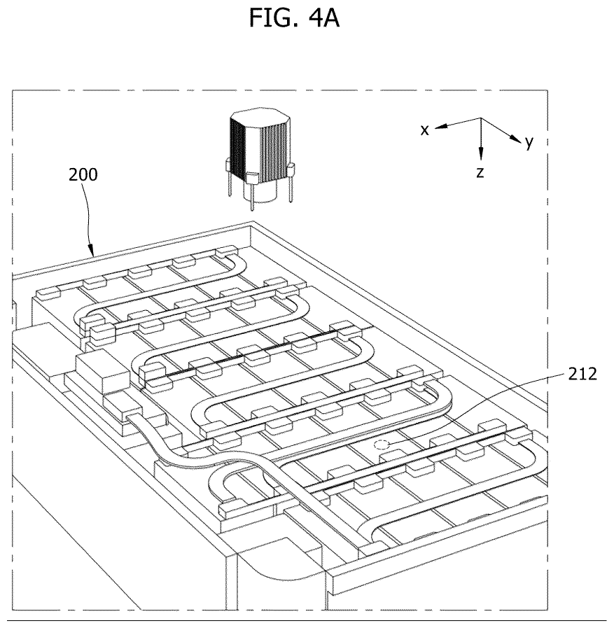

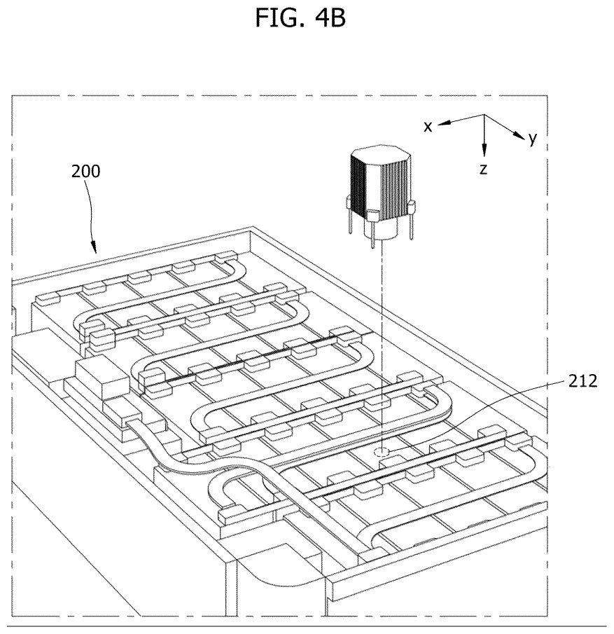

FIG. 1 is a block diagram illustrating a battery diagnosis system according to one or more embodiments of the present disclosure, and FIG. 2 is a view illustrating a location identification apparatus according to one or more embodiments of the present disclosure. FIG. 3 is a view illustrating an operating process of the location identification apparatus according to one or more embodiments of the present disclosure, and FIGS. 4A and 4B illustrate another operating process of the location identification apparatus according to one or more embodiments of the present disclosure.

Referring to FIGS. 1 and 2, the battery diagnosis system according to one or more embodiments of the present disclosure may include a location identification apparatus 100 and a battery pack 200.

The battery pack 200 may include a plurality of battery modules 210 and a primary battery management system (BMS) 220. The battery pack 200 may include a pack housing which may include an accommodation space for accommodating the plurality of battery modules 210. In various embodiments, the battery pack 200 may further include other components.

Each of the battery modules 210 may include a plurality of battery cells and a module housing. The battery module 210 may include the plurality of battery cells connected to each other in series or parallel. The battery modules 210 may be connected to each other in series or parallel.

The battery cells may be accommodated in the module housing in a stacked form. The battery cell may include a positive electrode lead and a negative electrode lead. Depending on the type of battery, cylindrical type, prismatic type, or pouch type battery cells may be used as the battery cells.

Instead of the battery module 210, the battery pack 200 may include one cell stack stacked together to form one module. The cell stack may be accommodated in the accommodation space of the pack housing or an accommodation space partitioned by a frame or partition.

The battery cell may generate a large amount of heat during charging/discharging. The generated heat may be accumulated in the battery cell and may accelerate the degradation of the battery cell. Accordingly, the battery pack 200 may further include a cooling member to suppress the degradation of the battery cell due to heat. The cooling member may be provided in a lower portion of the accommodation space in which the battery cell is provided, but is not limited thereto and may be provided in an upper portion or side surface thereof according to the battery pack 200.

Exhaust gases generated inside the battery cell under abnormal operating conditions known as thermal runaway or a thermal event of the battery cell may be discharged to the outside of the battery cell. The battery pack 200 or the battery module 210 may include an exhaust port and the like for discharging the exhaust gas in order to prevent damage to the battery pack 200 or the module by the exhaust gas.

Each of the battery modules 210 may include a sound wave generator 211 and a subordinate BMS 212.

The sound wave generator 211 may generate a sound signal under the control of the subordinate BMS 212. The sound wave generator 211 may be provided at the top of the battery module 210. For example, the sound wave generator 211 may be provided on a printed circuit board including the subordinate BMS 212. The sound signal generated by the sound wave generator 211 may be broadcast to the outside of the module. The sound wave generator 211 may be a directional sound wave generator configured to generate a sound signal in a direction perpendicular to the battery pack 200. The sound signal of the sound wave generator 211 may include identification information of the battery module 210. The identification information of the battery module 210 may include information for identifying the battery module 210, for example, an identification number.

The subordinate BMS 212 may manage the battery module 210. The subordinate BMS 212 may detect a state (voltage, current, temperature, and the like) of the battery module 210 to detect state information indicating the state of the battery module 210. The subordinate BMS 212 may detect a state (voltage, current, temperature, and the like) of each of the battery cells constituting the battery module 210 to detect state information indicating the state of each of the battery cells.

The subordinate BMS 212 may control the sound wave generator 211. If a sound generation signal output from the primary BMS 220 is received, the subordinate BMS 212 may generate a sound signal including identification information of the battery module 210 from the sound wave generator 211. The subordinate BMS 212 may generate a sound signal for a predetermined time. The subordinate BMS 212 may also repeatedly generate a sound signal a predetermined number of times.

The primary BMS 220 may manage the battery pack 200. The primary BMS 220 may detect a state (voltage, current, temperature, and the like) of the battery pack 200 to detect state information indicating the state of the battery pack 200. The primary BMS 220 may detect a state (voltage, current, temperature, and the like) of each of the battery modules 210 constituting the battery pack 200 to detect state information indicating the state of each of the battery modules 210.

The primary BMS 220 may communicate with each subordinate BMS 212 included in each battery module 210 in a wireless and/or wired manner. The primary BMS 220 may receive and process data transmitted from each subordinate BMS 212. The primary BMS 220 may transmit data to the subordinate BMS 212 to control the subordinate BMS 212. The primary BMS 220 may communicate with an external apparatus in a wireless and/or wired manner. The primary BMS 220 may communicate with a system for replacing a battery module. The primary BMS 220 may communicate with the location identification apparatus 100.

The primary BMS 220 may identify a battery module in which a failure occurs (hereinafter, a faulty battery module) among the plurality of battery modules 210 included in the battery pack 200 to detect identification information of the faulty battery module on the basis of at least one of the state information of the battery cell, the state information of the battery module 210, and the state information of the battery pack 200. The primary BMS 220 may also receive the identification information of the faulty battery module from an external apparatus.

The primary BMS 220 may check whether the subordinate BMS 212 is operating normally. In this case, the subordinate BMS 212 may be operating normally and the subordinate BMS 212 may control the sound wave generator 211 according to a sound generation signal output from the primary BMS 220 to generate a sound signal normally. If a failure occurs in a communication path between the primary BMS 220 and the subordinate BMS 212, and if the failure occurs in a communication path between the subordinate BMS 212 and the sound wave generator 211, in a case in which a failure occurs in the subordinate BMS 212, or in a case in which a failure occurs in the sound wave generator 211, the subordinate BMS 212 may not be operating normally.

For example, the primary BMS 220 may check whether the subordinate BMS 212 is operating normally through a process of outputting a confirmation signal to the subordinate BMS 212 and checking whether a response signal is output from the subordinate BMS 212 in response to the confirmation signal. The primary BMS 220 may also check whether the subordinate BMS 212 is operating normally through a process of outputting a test signal to the subordinate BMS 212 and checking whether the subordinate BMS 212 has generated a sound signal according to the test signal. In this case, the primary BMS 220 may communicate with the location identification apparatus 100 in order to check whether the subordinate BMS 212 has generated a sound signal. The primary BMS 220 may also receive identification information about the subordinate BMS 212 in which a failure occurs from an external apparatus.

The primary BMS 220 may determine one or more battery modules among the plurality of battery modules included in the battery pack 200 as location confirmation targets. In this case, the location confirmation target may be a battery module whose location is to be checked using the location identification apparatus 100. The location confirmation targets may include at least one battery module.

If all the subordinate BMSs 212 included in faulty battery modules are operating normally, the primary BMS 220 may determine the faulty battery modules as location confirmation targets. However, if at least one of the subordinate BMSs 212 included in the faulty battery modules is not operating normally, the primary BMS 220 may determine the remaining battery modules excluding the faulty battery modules as location confirmation targets.

In this case, if all the subordinate BMSs 212 included in the remaining battery modules excluding the faulty battery modules are operating normally, the primary BMS 220 may determine the remaining battery modules excluding the faulty battery modules as the location confirmation targets. If at least one of the subordinate BMSs 212 included in the remaining battery modules excluding the faulty battery modules is not operating normally, the primary BMS 220 may output a warning signal to the outside.

The primary BMS 220 may select one battery module included in the location confirmation targets as a target battery module and output a sound generation signal to the subordinate BMS 212 included in the target battery module. In this case, the sound generation signal may be a signal for requesting the generation of a sound signal. If the sound generation signal is received, the subordinate BMS 212 may control the sound wave generator 211 to generate the sound signal.

The primary BMS 220 may repeatedly perform a process of selecting one battery module included in the location confirmation targets as a target battery module and may output a sound generation signal to the subordinate BMS 212 included in the target battery module while changing a target battery module.

For example, if it is assumed that first and second battery modules are included in the location confirmation targets, the primary BMS 220 may select the first battery module as a target battery module and output a sound generation signal to a first subordinate BMS 212 included in the first battery module. Accordingly, the first subordinate BMS 212 may generate a sound signal from a first sound wave generator 211. The primary BMS 220 may then select the second battery module as a target battery module and output a sound generation signal to a second subordinate BMS 212 included in the second battery module. Accordingly, the second subordinate BMS 212 may generate a sound signal from a second sound wave generator 211. An output timing of the sound generation signal may be adjusted so that the sound signal is generated from the second sound wave generator 211 at a predetermined time after the generation of the sound signal from the first sound wave generator 211 is completed. The output timing of the sound generation signal may be set in consideration of a duration of a sound signal.

The location identification apparatus 100 may identify a location of a battery module (target battery module) which is generating a sound signal to generate location information of the target battery module. The location identification apparatus 100 may be provided at a location that is vertically spaced a predetermined distance from an upper end of the battery pack 200. The location identification apparatus 100 may include a microphone array 110, a camera 120, a moving device 130, a communication device 140, a memory 150, and a processor 160.

Components included in the location identification apparatus 100 may be connected through a common bus, or an individual interface or bus centered on the processor 160. The location identification apparatus 100 may further include various components in addition to the components illustrated in FIG. 1, and some components among the above components may be omitted.

The microphone array 110 may be provided on a main body 170 (see FIG. 2) of the location identification apparatus 100. The microphone array 110 may include a plurality of microphones 111 to 114. The microphones may receive a sound signal generated by the sound wave generator 211 provided in a target battery module. The microphone may be a directional microphone configured to receive a sound signal in a direction perpendicular to the main body 170 better than sound signals in other directions. The plurality of microphones 111 to 114 may be disposed to be spaced apart from each other. For example, as illustrated in FIG. 2, the microphone array 110 may include first to fourth microphones 111 to 114 that protrude downward from the main body 170 (see the orientation in FIG. 3). However, the number of microphones included in the microphone array 110 is not limited to the above-described embodiment, and the number of microphones constituting the microphone array may be smaller than four, or greater than or equal to four.

The camera 120 may be provided on the main body 170. The camera 120 may capture an image of the plurality of battery modules 210 included in the battery pack 200. For example, as illustrated in FIG. 2, the camera 120 may be provided on a lower portion of the main body 170 to capture the image of the plurality of battery modules 210 located under the main body 170. The camera 120 may be disposed in a direction perpendicular to the battery pack 200. The camera 120 may capture an image of an inner portion of the battery pack 200 in a state in which an upper cover of the battery pack 200 is removed.

The moving device 130 may move the main body 170. The moving device 130 may move the main body 170 on a plane parallel to an upper surface of the battery pack 200. For example, the moving device 130 may move the main body 170 on an X-Y plane of FIG. 3. For example, the moving device 130 may be a robot arm capable of multi-axis movement. As another example, the moving device 130 may be a rail device which moves along a rail. In addition, various types of the moving device 130 may be used to move the main body 170.

The communication device 140 may provide a communication interface for wired or wireless communication with the outside. The communication device 140 may receive arbitrary data from the outside and transmit the arbitrary data to the processor 160. The communication device 140 may transmit data calculated by the processor 160 to the outside.

Various types of information required in a process of operating the processor 160 may be stored in the memory 150. In addition, various types of information calculated in the process of operating the processor 160 may be stored in the memory 150.

The processor 160 may be operatively connected to the microphone array 110, the camera 120, the moving device 130, the communication device 140, and the memory 150. The processor 160 may be implemented as a central processing unit (CPU) or system on chip (SoC), may run an operating system or application to control a plurality of hardware or software components connected to the processor 160, and may perform various types of data processing and operations. The processor 160 may be configured to execute at least one command stored in the memory 150 and store the execution result data in the memory 150.

The processor 160 may capture an image of the plurality of battery modules using the camera 120. The processor 160 may receive a sound signal generated by a target battery module using the microphone array 110. The processor 160 may generate location information of the target battery module based on the image of the plurality of battery modules and the sound signal received from the microphone array 110. In this process, the processor 160 may move the main body 170 using the moving device 130.

The processor 160 may identify a region of each battery module from the captured image of the plurality of battery modules. The processor 160 may analyze the captured image of the plurality of battery modules and identify the region occupied by each battery module in the captured image. The processor 160 may calculate image coordinate information about the region of each battery module and store the image coordinate information in the memory 150. In this case, the processor 160 may move the main body 170 using the moving device 130 or adjust a focal length of the camera 120 to capture an image of all the battery modules included in the battery pack 200 as necessary. For example, as illustrated in FIG. 3, the processor 160 may capture the image of the plurality of battery modules at a location (hereinafter, a reference location) vertically spaced a predetermined distance from a center point of the battery pack 200. The processor 160 may store the image of the plurality of battery modules captured at the reference location in the memory 150.

The processor 160 may identify a location (hereinafter, a sound signal generation location) at which the sound signal is generated based on the captured image of the plurality of battery modules and the sound signal.

The processor 160 may identify the sound signal generation based on the strength of the sound signal received from each of the plurality of microphones 111 to 114 included in the microphone array 110. In this case, the processor 160 may move the main body 170 to the reference location using the moving device 130 before receiving the sound signal from the microphone array 110. Relationship information for detecting the sound signal generation location from information about the strength of the sound signal received from each microphone may be prestored in the memory 150, and the processor 160 may identify the sound signal generation location using the strength of the sound signal received from the microphone and the relationship information stored in the memory 150.

The processor 160 may move the main body 170 to a location at which the strength of the sound signal received from each of the plurality of microphones 111 to 114 included in the microphone array 110 is the same using the moving device 130, and then identify a location of the main body 170 based on an image captured by the camera 120 and identify the identified location of the main body 170 as the sound signal generation location.

The processor 160 may detect a direction in which a sound signal with a greater strength is received and move the main body 170 in the that direction. For example, if the strength of a sound signal received from a first microphone is greater than the strength of a sound signal received from a second microphone, the processor 160 may control the moving device 130 to move the main body 170 in a direction toward the first microphone from the second microphone. Meanwhile, if the strength of the sound signal received from the first microphone is greater than the strength of a sound signal received from a third microphone, the processor 160 may control the moving device 130 to move the main body 170 in a direction toward the first microphone from the third microphone. The processor 160 may repeatedly perform a process of moving the main body 170 to a location vertically above the sound wave generator 211 which generates a sound signal as in FIG. 4B from an initial location as in FIG. 4A.

If the sound wave generator 211, which generates a sound signal and the main body 170 are located on a vertical line, sound signals with the same strength may be received from the plurality of microphones 111 to 114 included in the microphone array 110. In some embodiments, the location where the strength of the sound signal received from each of the plurality of microphones 111 to 114 included in the microphone array 110 may be the same and may be used as a sound signal generation location.

The processor 160 may compare a current image captured by the camera 120 and an image (hereinafter, a reference image) captured at the reference location, and identify a current location of the main body 170 based on a comparison result. The processor 160 may identify the current location of the main body 170 by checking which direction and how far the main body 170 is located from the reference location from the result of comparing the current image and the reference image.

The processor 160 may identify a battery module corresponding to the region including the sound signal generation location as a target battery module. The processor 160 may check which region of the battery module includes the sound signal generation location and identify the battery module which occupies the region including the sound signal generation location as the target battery module.

The processor 160 may generate information about the region of the target battery module as location information. The processor 160 may generate information about the region occupied by the target battery module (for example, image coordinate information about the region of the target battery module) in the image as location information.

The processor 160 may repeatedly perform a process of generating the location information of the target battery module whenever a sound signal is received from the microphone array 110. The processor 160 may repeatedly perform the process of generating the location information of the target battery module until the sound signal is not received for a predetermined time or more.

The processor 160 may detect identification information of the target battery module from the sound signal received from the microphone array 110. The processor 160 may analyze or interpret the sound signal received from the microphone array 110 to detect the identification information of the target battery module included in the sound signal. The processor 160 may match and store the identification information of the target battery module and the location information of the target battery module.

If reception of the sound signal is completed, the processor 160 may identify the battery module for which location information is generated as a location confirmation target. If the sound signal is not received for a predetermined time or more after a reception time of the sound signal, the processor 160 may determine that the reception of the sound signal is completed. The processor 160 may determine that all battery modules identified as the target battery modules are included in the location confirmation targets.

The processor 160 may determine whether the battery module included in the location confirmation target is a faulty battery module. The primary BMS 220 may transmit information about whether the battery module included in the location confirmation target is a faulty battery module using wired or wireless communication. The processor 160 may receive corresponding information from the primary BMS 220 from the communication device 140 and determine whether the battery module included in the location confirmation target is a faulty battery module based on the received information.

The subordinate BMS 212 may generate a separate sound signal if the battery module included in the location confirmation target is a faulty battery module using the sound wave generator 211. The processor 160 may also receive the corresponding sound signal from the microphone array 110 and determine whether the battery module included in the location confirmation target is a faulty battery module based on the received sound signal.

If the battery module included in the location confirmation target is a faulty battery module, the processor 160 may collect location information about all battery modules included in the location confirmation targets and output the collected location information using the communication device 140. For example, the processor 160 may display regions of all the battery modules included in the location confirmation targets on a captured image of the plurality of battery modules included in the battery pack 200 separately from the other regions to generate map data and transmit the generated map data to the outside. The map data may be used in a system and the like for replacing battery modules. The processor 160 may also output the identification information of the battery modules included in the location confirmation targets with the location information.

Meanwhile, if the battery module included in the location confirmation target is not a faulty battery module, the processor 160 may generate and collect location information about the remaining battery modules (that is, faulty battery modules) excluding the battery module (that is, a normal battery module) included in the location confirmation target among the plurality of battery modules included in the battery pack 200 and output the location information using the communication device 140. For example, the processor 160 may display regions of the remaining battery modules excluding the battery module included in the location confirmation target on the captured image of the plurality of battery modules included in the battery pack 200 separately from the other regions to generate map data and transmit the map data to the outside.

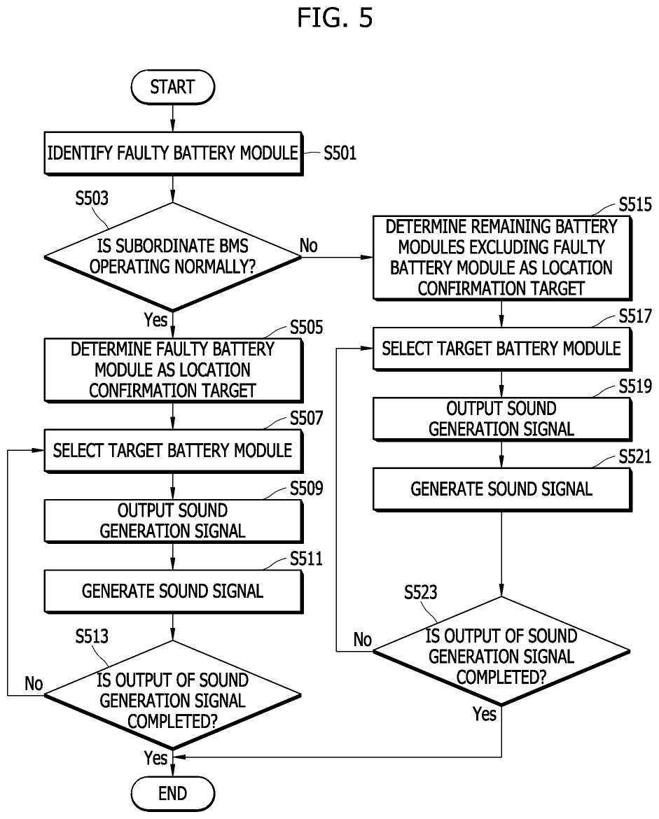

FIG. 5 is a flowchart illustrating an operating method of the primary BMS and the subordinate BMS included in the battery diagnosis system according to one or more embodiments of the present disclosure.

An operating method of the primary BMS 220 and the subordinate BMS 212 will be described with reference to FIG. 5. Among processes which will now be described below, some processes may be performed in an order different from the order described below or may be omitted. Meanwhile, detailed descriptions of content overlapping the above-described content will be omitted, and time-series content will be mainly described below.

Referring to FIG. 5, initially, the primary BMS 220 may identify faulty battery modules among the plurality of battery modules included in the battery pack 200 (S501). The primary BMS 220 may identify one or more battery modules among the plurality of battery modules included in the battery pack 200 as the faulty battery modules.

Then, the primary BMS 220 may check whether all the subordinate BMSs 212 corresponding to the faulty battery modules are operating normally (S503). The primary BMS 220 may check whether each subordinate BMS 212 corresponding to a faulty battery module is operating normally by performing a process in which the primary BMS 220 outputs test signals to the subordinate BMSs 212 and checks whether the subordinate BMSs 212 have generated sound signals according to the test signal for each subordinate BMS 212.

If all the subordinate BMSs 212 corresponding to the faulty battery modules are operating normally, the primary BMS 220 may determine the faulty battery modules as location confirmation targets (S505).

The primary BMS 220 may then select one battery module included in the location confirmation targets as a target battery module (S507). The primary BMS 220 may select a battery module which has not been selected as the target battery module among the battery modules included in the location confirmation targets as a target battery module.

The primary BMS 220 may thereafter output a sound generation signal to the subordinate BMS 212 provided in the target battery module (S509).

Subsequently, the subordinate BMS 212 included in the target battery module may generate a sound signal using the sound wave generator 211 (S511). The sound signal generated by the sound wave generator 211 may be received by the location identification apparatus 100. The location identification apparatus 100 may generate location information of the target battery module based on the sound signal. The location identification apparatus 100 may also detect identification information of the target battery module from the sound signal and match and store the detected identification information with the location information.

The primary BMS 220 may determine whether the output of sound generation signals for all the battery modules included in the location confirmation targets is completed (S513).

If the output of the sound generation signals for all the battery modules included in the location confirmation targets is not completed, the primary BMS 220 may perform operation S507 again. On the other hand, if the output of the sound generation signals for all the battery modules included in the location confirmation targets is completed, the primary BMS 220 may terminate the process of FIG. 5.

Meanwhile, if at least one of the subordinate BMSs 212 corresponding to the faulty battery modules is not operating normally, the primary BMS 220 may determine the remaining battery modules excluding the faulty battery module as a location confirmation target (S515). In operation S515, the primary BMS 220 may check whether all the remaining battery modules excluding the faulty battery module are operating normally. If at least one of the remaining battery modules excluding the faulty battery module is not operating normally, the primary BMS 220 may output a warning signal to the outside and terminate the process of FIG. 5.

The primary BMS 220 may then select one battery module included in the location confirmation targets as a target battery module (S517). The primary BMS 220 may select a battery module which has not been selected as the target battery module among the battery modules included in the location confirmation targets as a target battery module.

Then, the primary BMS 220 may output a sound generation signal to the subordinate BMS 212 included in the target battery module (S519).

The subordinate BMS 212 included in the target battery module may then generate a sound generation signal using the sound wave generator 211 (S521). The sound signal generated by the sound wave generator 211 may be received by the location identification apparatus 100. The location identification apparatus 100 may generate location information of the target battery module based on the sound signal. The location identification apparatus 100 may also detect identification information of the target battery module from the sound signal and match and store the detected identification information with the location information.

The primary BMS 220 may determine whether the output of sound generation signals for all the battery modules included in the location confirmation targets is completed (S523).

If the output of the sound generation signals for all the battery modules included in the location confirmation targets is not completed, the primary BMS 220 may perform operation S517 again. On the other hand, if the output of the sound generation signals for all the battery modules included in the location confirmation targets is completed, the primary BMS 220 may terminate the process of FIG. 5.

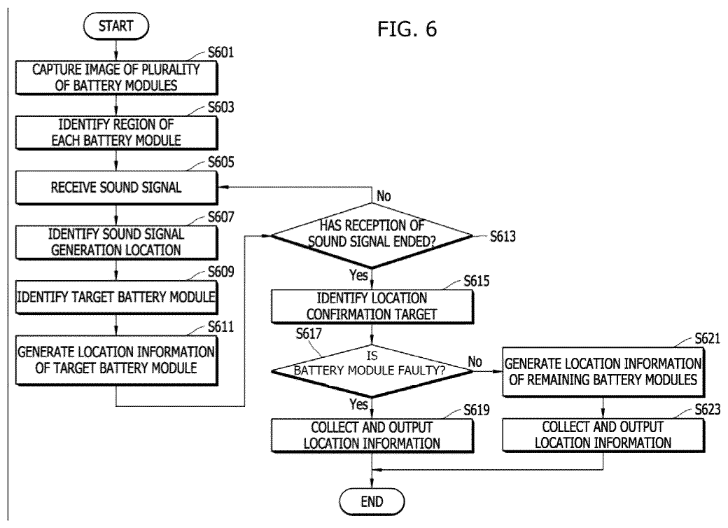

FIG. 6 is a flowchart illustrating an operating method of the location identification apparatus included in the battery diagnosis system according to one or more embodiments of the present disclosure.

Hereinafter, an operating method of the location identification apparatus 100 will be described with reference to FIG. 6. Among the processes which will be described below, some processes may be performed in an order different from the order described below or may be omitted. Meanwhile, detailed descriptions of content overlapping the above-described content will be omitted, and time-series content will be mainly described below.

Initially, the location identification apparatus 100 may capture an image of the plurality of battery modules included in the battery pack 200 using the camera 120 (S601). In some embodiments, before operation S601, the location identification apparatus 100 may move the main body 170 to a reference location using the moving device 130.

The location identification apparatus 100 may then identify a region of each battery module from the captured image of the plurality of battery modules (S603). In operation S603, the location identification apparatus 100 may calculate and store image coordinate information about the region of each battery module.

Then, the location identification apparatus 100 may receive a sound signal from the microphone array 110 (S605) and identify a sound signal generation location based on the received sound signal (S607). In operation S607, the location identification apparatus 100 may identify the sound signal generation location based on the strength of sound signals received from the plurality of microphones 111 to 114 included in the microphone array 110.

The location identification apparatus 100 may then identify a battery module corresponding to a region including the sound signal generation location as a target battery module (S609). In operation S609, the location identification apparatus 100 may identify the battery module occupying the region including the sound signal generation location as the target battery module.

Then, the location identification apparatus 100 may generate location information of the target battery module (S611). In operation S611, the location identification apparatus 100 may generate information about the region of the target battery module (for example, image coordinate information about the region of the target battery module) as location information.

The location identification apparatus 100 may then determine whether the reception of the sound signal has ended (S613). In operation S613, if the sound signal is not received again within a preset time from the time at which the last sound signal is received, the location identification apparatus 100 may determine that the reception of the sound signal has ended.

If the reception of the sound signal has not ended, the location identification apparatus 100 may perform operation S605 again. On the other hand, if the reception of the sound signal has ended, the location identification apparatus 100 may identify the battery module for which location information has been completely generated as a location confirmation target (S615).

The location identification apparatus 100 may determine whether the battery module included in the location confirmation target is a faulty battery module (S617). In operation S617, the location identification apparatus 100 may determine whether the battery module included in the location confirmation target is a faulty battery module based on the sound signal received from the sound wave generator 211 or information received from the communication device 140.

If the battery module included in the location confirmation target is a faulty battery module, the location identification apparatus 100 may collect and output location information about all the battery modules included in the location confirmation targets (S619).

On the other hand, if the battery module included in the location confirmation target is not a faulty battery module, the location identification apparatus 100 may generate location information about the remaining battery modules excluding the battery module included in the location confirmation target among the plurality of battery modules included in the battery pack 200 (S621).

Then, the location identification apparatus 100 may collect and output the location information about the remaining battery modules excluding the battery module included in the location confirmation target (S623).

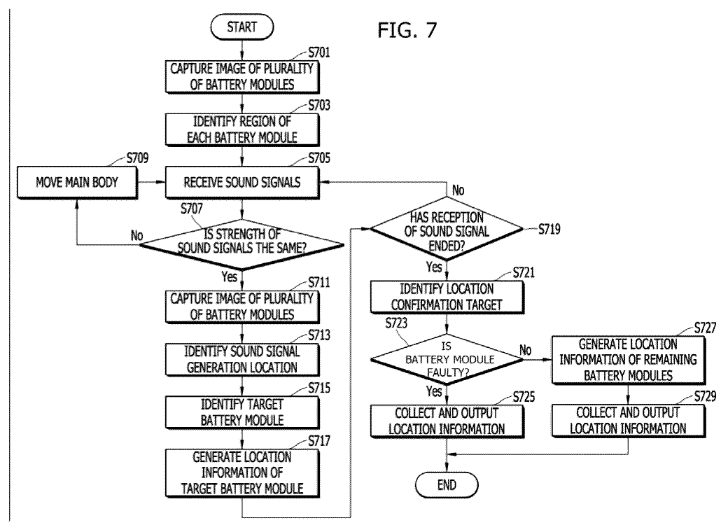

FIG. 7 is a flowchart illustrating another operating method of the location identification apparatus included in the battery diagnosis system according to one or more embodiments of the present disclosure.

Another operating method of the location identification apparatus 100 will now be described with reference to FIG. 7. Among processes which will be described below, some processes may be performed in an order different from the order described below or may be omitted. Meanwhile, detailed descriptions of content overlapping the above-described content will be omitted, and time-series content will be mainly described below.

Initially, the location identification apparatus 100 may capture an image of the plurality of battery modules included in the battery pack 200 using the camera 120 (S701). In some embodiments, before operation S701, the location identification apparatus 100 may move the main body 170 to a reference location using the moving device 130.

Then, the location identification apparatus 100 may identify a region of each battery module from the captured image of the plurality of battery modules (S703). In operation S703, the location identification apparatus 100 may calculate and store image coordinate information about the region of each battery module.

The location identification apparatus 100 may then receive a sound signal from the microphone array 110 (S705) and determine whether the strength of the sound signal received from each of the plurality of microphones 111 to 114 included in the microphone array 110 is the same (S707).

If the strength of the sound signal received from each of the plurality of microphones 111 to 114 is not the same, the location identification apparatus 100 may move the main body 170 using the moving device 130 (S709) and perform operation S705 again.

On the other hand, if the strength of the sound signal received from each of the plurality of microphones 111 to 114 is the same, the location identification apparatus 100 may capture an image of the plurality of battery modules using the camera 120 (S711).

Then, the location identification apparatus 100 may identify a sound signal generation location based on the captured image of the plurality of battery modules (S713). The location identification apparatus 100 may identify a current location of the main body 170 in the captured image of the plurality of battery modules and identify the identified current location of the main body 170 as the sound signal generation location.

The location identification apparatus 100 may then identify a battery module corresponding to a region including the sound signal generation location as a target battery module (S715). In operation S715, the location identification apparatus 100 may identify the battery module occupying the region including the sound signal generation location as the target battery module.

The location identification apparatus 100 may generate location information of the target battery module (S717). In operation S717, the location identification apparatus 100 may generate information about the region of the target battery module (for example, image coordinate information about the region of the target battery module) as location information.

The location identification apparatus 100 may determine whether the reception of a sound signal has ended (S719). In operation S719, the location identification apparatus 100 may determine that the reception of the sound signal has ended if the sound signal is not received again within a predetermined time from the time at which the last sound signal is received.

If the reception of the sound signal has not ended, the location identification apparatus 100 may perform operation S705 again. On the other hand, if the reception of the sound signal has ended, the location identification apparatus 100 may identify the battery module for which the location information has been completely generated as a location confirmation target (S721).

The location identification apparatus 100 may then determine whether the battery module included in the location confirmation target is a faulty battery module (S723). In operation S723, the location identification apparatus 100 may determine whether the battery module included in the location confirmation target is a faulty battery module based on the sound signal received from the sound wave generator 211 or information received from the communication device 140.

If the battery module included in the location confirmation target is a faulty battery module, the location identification apparatus 100 may collect and output location information about all battery modules included in the location confirmation targets (S725).

On the other hand, if the battery module included in the location confirmation target is not a faulty battery module, the location identification apparatus 100 may generate location information about the remaining battery modules excluding the battery module included in the location confirmation target among the plurality of battery modules included in the battery pack 200 (S727).

The location identification apparatus 100 may then collect and output the location information about the remaining battery modules excluding the battery module included in the location confirmation target (S729).

As described above, according to embodiments herein, the location of a faulty battery module can be accurately identified using a sound signal generated by the faulty battery module.

However, effects which can be achieved through the present disclosure are not limited to the above-described effects, and other effects which are not described above will be clearly understood by those of ordinary skill in the art from the description of the present embodiments described above.

Embodiments herein can be implemented using, for example, a method, a process, an apparatus, a software program, a data stream, or a signal. Even if an embodiment(s) of the present disclosure is described as being implemented in only a single form (for example, as a method), the described features may be implemented in another form (for example, as an apparatus or program). The apparatus may be implemented using proper hardware, software, firmware, or the like. For example, the method may be implemented in an apparatus such as a processor which generally refers to a processing device such as a computer, a microprocessor, an integrated circuit, and a programmable logic device. The processor includes a communication device such as a computer, a cell phone, a portable/personal digital assistant (PDA) terminal, and other devices which facilitate communication of information between end-users.

While embodiments have been described with reference to embodiments illustrated in the accompanying drawings, this is merely exemplary. It will be understood by those of ordinary skill in the art that various modifications and other equivalent example embodiments may be made from the embodiments herein. Therefore, the scope of the embodiments herein is defined by the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module location identification apparatus which identifies a location of a target battery module among a plurality of battery modules included in a battery pack using a sound signal generated from the target battery module, the battery module location identification apparatus comprising:
a microphone array including a plurality of microphones;
a camera; and
a processor connected to the microphone array and the camera,
wherein the processor generates location information of the target battery module based on an image of the plurality of battery modules captured by the camera and a sound signal received from the microphone array.

2. The battery module location identification apparatus as claimed in claim 1, wherein the processor:
identifies a region of each battery module from the image;
identifies a generation location of the sound signal;
identifies a battery module corresponding to a region including the generation location of the sound signal as the target battery module; and
generates information about the region of the target battery module as the location information.

3. The battery module location identification apparatus as claimed in claim 2, wherein the processor identifies the generation location of the sound signal based on a strength of the sound signal received from each of the plurality of microphones at a reference location.

4. The battery module location identification apparatus as claimed in claim 2, further comprising a moving device which moves a main body including the microphone array and the camera on a plane parallel to an upper surface of the battery pack.

5. The battery module location identification apparatus as claimed in claim 4, wherein the processor:
moves the main body to a location where a strength of the sound signal received from each of the plurality of microphones is the same using the moving device;
identifies a location of the main body based on the image captured by the camera; and
identifies the location of the main body as the generation location of the sound signal.

6. The battery module location identification apparatus as claimed in claim 1, wherein:
the sound signal includes identification information of the target battery module; and
the processor detects the identification information of the target battery module from the sound signal and matches and stores the detected identification information and the location information of the target battery module.

7. A battery module location identification method which identifies a location of a target battery module among a plurality of battery modules included in a battery pack using a sound signal output from the target battery module, the battery module location identification method comprising:
capturing, by a camera, an image of the plurality of battery modules;
receiving a sound signal from a microphone array; and
generating location information of the target battery module based on the image captured by the camera and the sound signal received from the microphone array.

8. The battery module location identification method as claimed in claim 7, wherein the generating of the location information includes:
identifying a region of each battery module from the image;
identifying a generation location of the sound signal;
identifying a battery module corresponding to a region including the generation location of the sound signal as the target battery module; and
generating information about the region of the target battery module as the location information.

9. The battery module location identification method as claimed in claim 8, wherein the identifying of the generation location includes identifying the generation location of the sound signal based on a strength of the sound signal received from each of a plurality of microphones of the microphone array at a reference location.

10. The battery module location identification method as claimed in claim 8, wherein the identifying of the generation location of the sound signal includes:
moving a main body including the microphone array and the camera to a location where a strength of the sound signal received from each of a plurality of microphones included in the microphone array is the same using a moving device;
identifying a location of the main body based on the image captured by the camera; and
identifying the location of the main body as the generation location of the sound signal.

11. The battery module location identification method as claimed in claim 7, further comprising:
detecting identification information of the target battery module from the sound signal; and
matching and storing the detected identification information and the location information of the target battery module.

12. A battery diagnosis system comprising:
a plurality of subordinate battery management systems (BMSs) included in battery modules; and
a primary BMS which communicates with the plurality of subordinate BMSs, wherein:
the primary BMS determines some of a plurality of battery modules included in a battery pack as location confirmation targets and repeatedly performs a process of selecting one battery module included in the location confirmation targets as a target battery module and outputting a sound generation signal to a subordinate BMS included in the target battery module while changing the target battery module, and
if the sound generation signal is received, the subordinate BMS generates a sound signal using a sound wave generator included in the target battery module.

13. The battery diagnosis system as claimed in claim 12, wherein the primary BMS:
identifies one or more faulty battery modules among the plurality of battery modules; and
determines the one or more faulty battery modules as the location confirmation targets.

14. The battery diagnosis system as claimed in claim 13, wherein, if all subordinate BMSs included in the faulty battery modules are operating normally, the primary BMS determines the one or more faulty battery modules as the location confirmation targets.

15. The battery diagnosis system as claimed in claim 14, wherein, if at least one of the one or more faulty battery modules is not operating normally, the primary BMS determines remaining battery modules excluding the one or more faulty battery modules as the location confirmation targets.

16. The battery diagnosis system as claimed in claim 12, wherein the subordinate BMS includes identification information of the target battery module in the sound signal.

17. The battery diagnosis system as claimed in claim 12, further comprising a location identification apparatus including a microphone array, the microphone array including a plurality of microphones and a camera,
wherein the location identification apparatus generates location information of the target battery module based on an image of a plurality of battery modules captured by the camera and a sound signal received from the microphone array.

18. The battery diagnosis system as claimed in claim 17, wherein the location identification apparatus:
identifies a region of each battery module from the image;
identifies a generation location of the sound signal; and
generates information about a region including the generation location of the sound signal as the location information of the target battery module.

19. The battery diagnosis system as claimed in claim 17, wherein:
if reception of the sound signal has ended, the location identification apparatus identifies a battery module for which the location information is completely generated as the location confirmation target; and
if the battery module included in the location confirmation target is a faulty battery module, the location identification apparatus collects and outputs location information of all the battery modules included in the location confirmation targets.

20. The battery diagnosis system as claimed in claim 19, wherein, if the battery module included in the location confirmation target is not a faulty battery module, the location identification apparatus generates location information of remaining battery modules excluding the battery modules included in the location confirmation targets and collects and outputs location information of the remaining battery modules.
